(19) United States
(12) Patent Application Publication
(10) Pub. No.: US 2017/0063761 A1
(43) Pub. Date: Mar. 2, 2017

(54) Accessing Computers via Text Messages

(71) Applicants: Hong-Zhou Tan, Guangzhou (CN); Shiyan Hu, Kanata (CA)

(72) Inventors: Hong-Zhou Tan, Guangzhou (CN); Shiyan Hu, Kanata (CA)

(73) Assignee: SYSU Huadu Industrial Science and Technology Institute, Guangzhou (CN)

(21) Appl. No.: 14/839,945

(22) Filed: Aug. 29, 2015

(51) Int. Cl. H04L 12/58; H04L 29/08

(52) U.S. Cl. CPC H04L 51/18; H04L 51/38; H04L 67/025

(57) ABSTRACT

The present invention relates to a method to employ text messages via short message services (SMS) to remotely access computers for advanced data service. A remote wireless user can send text messages with specific query formats to a local short message service receiver, which is in turn, connected to a computer. The computer identifies the query and initiates a data service session to perform relevant tasks online or offline. Various additional devices can be linked to a local network using the same method.

### CROSS-REFERENCES TO RELATED APPLICATIONS

None

### TECHNICAL FIELD

The present invention relates to a method to employ text messages via short message services (SMS) to remotely access computers for advanced data service.

### BACKGROUND OF THE INVENTION

Text message is a mechanism of sending and receiving short messages over a mobile phone network. It uses standardized communication protocols to transmit text messages to, or receive text messages from, mobile phones, fax machines, or simply IP addressed entities. Usually, each short message must be no more than 160 characters in length (224 characters if using a 5-bit mode) and does not contain any images or graphics.

The function of texting is compatible with almost every mobile device on the market. The act of texting is also extremely popular across age and culture groups due to its low cost and efficiency. To this day, feature mobile devices, which largely support voice calls and texting only, still out sell smart phones. Because smart phones are more expensive and require users to purchase additional data service packages on top of the phone services.

There are numerous attempts to expand the functionality of text messages while keeping costs low. U.S. Pat. No. 8,577,401 disclosed a method to cloak mobile phone numbers by manipulating the numbers based on the origin of the text message. U.S. Pat. No. 8,285,273 disclosed a method for conducting search functions via text message services connected to search engines. Apps, such as “MightyText”, allows a user to either text from a mobile phone or from a personal computer (PC), and synchronize the two devices whenever possible.

Broadband Internet services are widely available nowadays and are increasingly being integrated as a type of basic utility. If a user has computers or computer networks set up at home (or at any business) and connected to the Internet, the user typically has access to data services with a capacity far exceeds what a mobile phone data package can offer. The present invention provides a method for a user to remotely tap into this existing resource from a simple feature mobile device via texting, and to access computer functions online or offline, without having to subscribe to extra mobile phone data packages.

### BRIEF SUMMARY OF EMBODIMENTS OF THE INVENTION

The present invention relates to a method to employ text messages via short message services (SMS) to remotely access computers for advanced data service.

In a variant, the method for accessing computers via text messages comprises the steps of receiving a first text message from a wireless unit by a local short message service receiver connected to a computer; converting the first text message into executable commands for the computer; executing commands via the computer; converting results from the computer back into a second text message; and sending the second text message from the local short message service receiver to the wireless unit.

In another variant, the local short message service receiver is connected to the computer via a universal serial bus.

In yet another variant, the local short message service receiver is connected to the computer via a local wireless network.

In still another variant, the local short message service receiver is a landline phone.

In a variant, the local short message service receiver is an IP phone.

In another variant, the first and the second text messages are encrypted.

In yet another variant, the local short message service receiver unit is programmed to initiate data service session only from preset numbers.

In still another variant, GPS signals of the wireless unit are shared in the data service session.

Other features and aspects of the invention will become apparent from the following detailed description, taken in conjunction with the accompanying drawings, which illustrate, by way of example, the features in accordance with embodiments of the invention. The summary is not intended to limit the scope of the invention, which is defined solely by the claims attached hereto.

### BRIEF DESCRIPTION OF THE DRAWINGS

The present invention, in accordance with one or more various embodiments, is described in detail with reference to the following figures. The drawings are provided for purposes of illustration only and merely depict typical or example embodiments of the invention. These drawings are provided to facilitate the reader's understanding of the invention and shall not be considered limiting of the breadth, scope, or applicability of the invention. It should be noted that for clarity and ease of illustration these drawings are not necessarily made to scale.

Some of the figures included herein illustrate various embodiments of the invention from different viewing angles. Although the accompanying descriptive text may refer to such views as “top,” “bottom” or “side” views, such references are merely descriptive and do not imply or require that the invention be implemented or used in a particular spatial orientation unless explicitly stated otherwise.

FIG. 1 is a block diagram illustrating the components required to send and to receive text messages via a short message service center (SMC).

FIG. 2 is a block diagram illustrating the components required to set up a local SMS receiver connected to a computer that has Internet connection.

FIG. 3 is a flow chart illustrating exemplary steps involved in submitting queries and receiving results by using text messages to access computers connected to the regular Internet, according to some embodiments of the present invention.

FIG. 4 is a flow chart illustrating an exemplary dialog between the wireless feature mobile device and its user for inputting and receiving a search query according to some embodiments of the present invention.

FIG. 5 is a schematic of various hardware options to tap into the service provided by the present invention.

The figures are not intended to be exhaustive or to limit the invention to the precise form disclosed. It should be understood that the invention can be practiced with modification and alteration, and that the invention be limited only by the claims and the equivalents thereof.

### DETAILED DESCRIPTION OF THE EMBODIMENTS OF THE INVENTION

From time-to-time, the present invention is described herein in terms of example environments. Description in terms of these environments is provided to allow the various features and embodiments of the invention to be portrayed in the context of an exemplary application. After reading this description, it will become apparent to one of ordinary skill in the art how the invention can be implemented in different and alternative environments.

Unless defined otherwise, all technical and scientific terms used herein have the same meaning as is commonly understood by one of ordinary skill in the art to which this invention belongs. All patents, applications, published applications and other publications referred to herein are incorporated by reference in their entirety. If a definition set forth in this section is contrary to or otherwise inconsistent with a definition set forth in applications, published applications and other publications that are herein incorporated by reference, the definition set forth in this document prevails over the definition that is incorporated herein by reference.

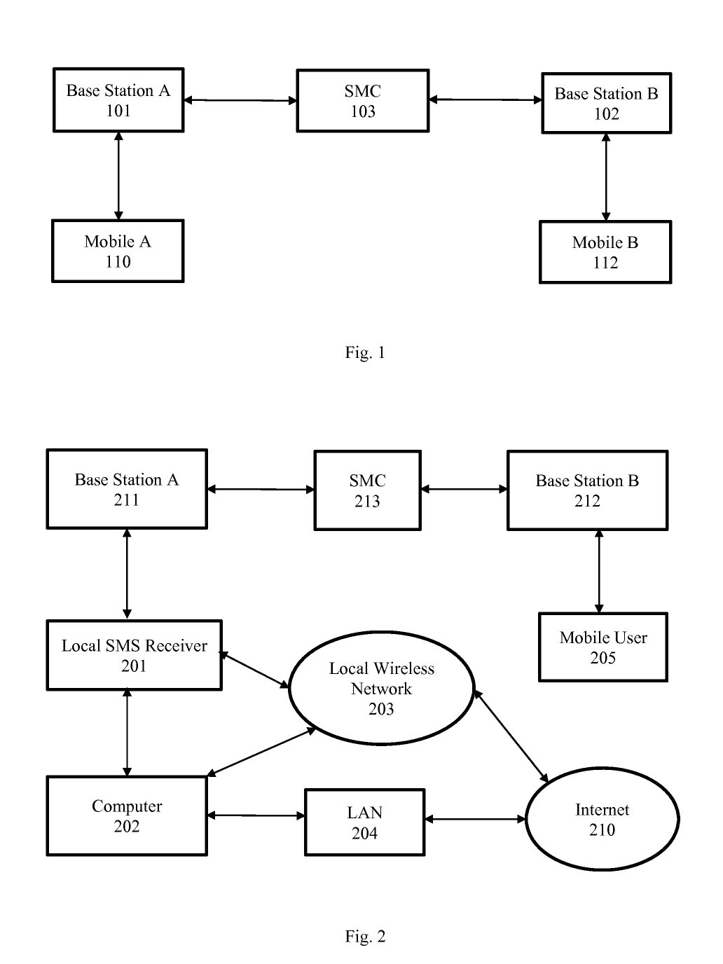

FIG. 1 is a block diagram illustrating several components required to send and to receive text messages via a short message service center (SMC). When Mobile A 110 sends out a short message, it is first received by the closest Base station A 101, provided by the senders mobile phone service. The short message is then forwarded to a central Short Message Center (SMC) 103, which is in charge of receiving, sorting, storing and forwarding the message to Base station B 102, closest to the intended message recipient holding Mobile B 112. If Mobile B 112 is not in range, the SMC 103 can put the short message on hold in its system for a certain amount of time, and then deliver the message once Mobile B 112 becomes in range and available.

FIG. 2 is a block diagram illustrating the components required to set up a local short message service (SMS) Receiver 201, connected to a Computer 202 that has internet 210 access. The basic set up is similar to that of in FIG. 1. Mobile A 101 from FIG. 1 is replaced with a Local SMS Receiver 201, which is connected to a Computer 202. The Computer 202 is connected to the Internet 210 via a Local Wireless Network 203 or via LAN 204 (Local Area Network). Mobile User 205 can send and receive text messages from the Local SMS Receiver 201 (via Base Station B 212, SMC 213, and Base Station A 211), which also has connections to the Computer 202 and its Internet service. The Local SMS Receiver 201 can be physically connected to the Computer 202 via a USB cable. The connection between the two can also be wirelessly established via the Local Wireless Network 203.

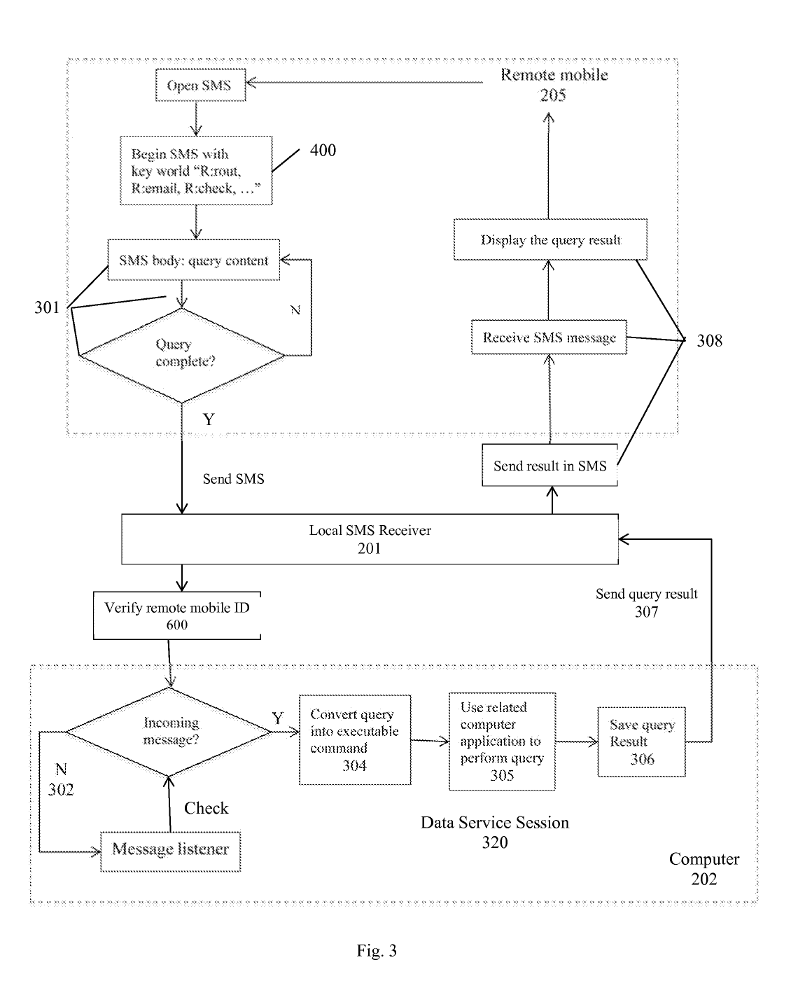

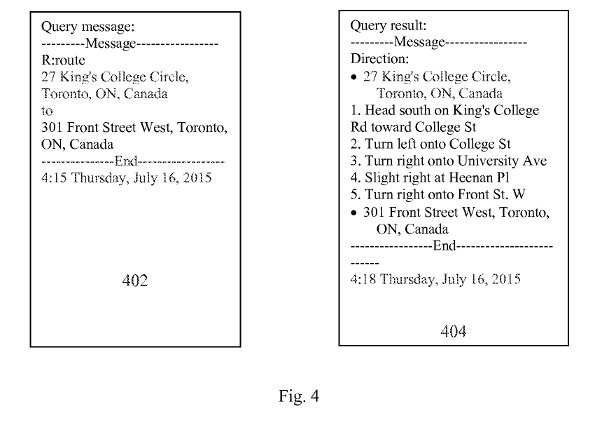

While FIG. 2 illustrates the components needed in the present invention, FIG. 3 further illustrates an exemplary embodiment of the functionalities of each component. For instance, a remote mobile user 205 opens a SMS application on his or her mobile phone to draft a short query message to access a remote computer 202. In order to be distinguished from regular short messages, a query short message needs to conform to a pre-specified format. An example of such a format will be illustrated in FIG. 4 later. After the query short message is confirmed at step 301, it is then sent via SMC to the Local SMS Receiver 201. The Local SMS Receiver identifies the incoming mobile number, receives the query message, and then forwards this information to the computer 202.

The computer 202 will run a step 302 to check if the SMS is indeed a query message. If the SMS is not a query message, the computer simply leaves the local SMS receiver to perform its regular function, such as recording the SMS or leaving a voice message.

If the SMS is indeed a query message, the computer 202 initiates a Data Service Session 320, which comprises the steps of converting the query message into executable commands 304, initiating corresponding software applications on the computer to execute the commands 305, and saving the results of the executed command 306. The results of the data service session are then sent back to the Local SMS Receiver 201 at step 307.

Upon receiving the output of various query results from the computer, the Local SMS Receiver 201 initiates an outgoing SMS message and sends these results via step 308 to the remote mobile user 205.

FIG. 4 illustrates an exemplary user experience as described in the above process. 402 depicts an exemplary query message, which in this case, is to inquire about a route from address A to address B. Query Term “R” and “route” refers to a route search. The two addresses that follow are to be identified as the starting and ending addresses. Once the computer 202 identifies an incoming query message and may initiate a Data Service Session 320, the computer performs a route search from address A to the destination address B, using Google map for example, and saves the direction of the route into a text file. 404 depicts an exemplary result of the query message received by the user, with directions in listed steps.

In case of route type queries, the remote mobile user 205 can also submit its present location based on the mobile's GPS signal as part of the query. This is particularly useful, for instance, if the user wishes to navigate to a second location from his or her current location, or for another user to navigate to his or her current location in reverse order. The incorperation of the mobile's GPS signal can also facilitate the identification and location of the user or the mobile device itself.

Another example of a query message can be for an email check, and is initiated with Query Term “R:email<email address>”. The email address is optional as one or more email address may be predefined to be associated with the phone number of a remote mobile user requesting the email check. The computer will read the query message and search for newly arrived emails in one or more email addresses and then send email subject headers as a response back. If more than one email subject headers are returned, they can be numerically listed. If the remote mobile user wants to read a specific email, another request with Query Term “R:email#n” may be sent to read email #n in the list. Different Query Terms can be generated for contact information check, home security system status check, weather check etc. It is to be noted that Query Terms can vary depending on the nature of the inquiry. New terms can be generated and updated for future uses.

Many data encryption/decryption algorithms can be adopted for secured data transmission. FIG. 3 also introduces an additional step 600 to verify remote mobile ID. More specifically, the system can be set to only initiate a Data Service Session for a predefined set of numbers. For instance, only family members' numbers can initiate a Data Service Session. In another instance, only numbers of a group of co-workers can access this function. The verification process can be programmed to recognize passwords associated with the preset or unknown numbers. The verification process can also be programmed to allow one member of the group to identify the location of another member (or of a device), based on its GPS signals.

The Local SMS Receiver 201 can be a regular mobile phone, a landline phone, or even an IP phone. The only requirement is that it can receive and send SMS messages.

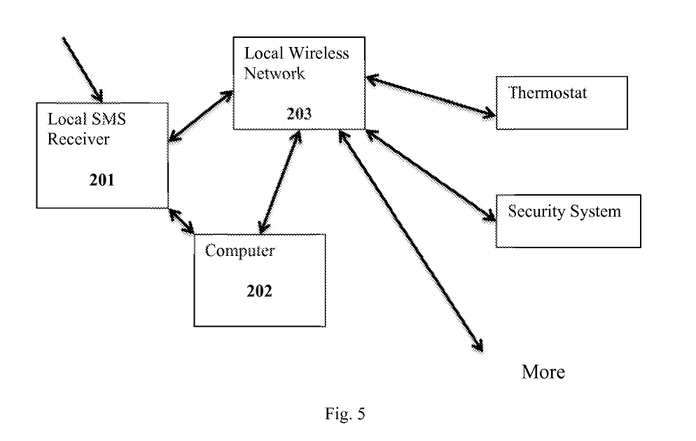

FIG. 5 illustrates a Local Wireless Network 203 connected to a Local SMS Receiver 201, a Computer 202, a security system, a thermostat, and a garage door opener etc. With more and more hardware programed to link with the Local Wireless Network, Query Terms can be expanded to accept SMS messages to perform additional functions directed to each and every entity on the network. The method can also be deployed to retrieve information directly from the computer itself, disregarding whether the computer is online or not.

While various embodiments of the present invention have been described above, it should be understood that they have been presented by way of example only, and not of limitation. Likewise, the various diagrams may depict an example architectural or other configuration for the invention, which is done to aid in understanding the features and functionality that can be included in the invention. The invention is not restricted to the illustrated example architectures or configurations, but the desired features can be implemented using a variety of alternative architectures and configurations. Indeed, it will be apparent to one of skill in the art how alternative functional, logical or physical partitioning and configurations can be implemented to implement the desired features of the present invention. Also, a multitude of different constituent module names other than those depicted herein can be applied to the various partitions. Additionally, with regard to flow diagrams, operational descriptions and method claims, the order in which the steps are presented herein shall not mandate that various embodiments be implemented to perform the recited functionality in the same order unless the context dictates otherwise.

Although the invention is described above in terms of various exemplary embodiments and implementations, it should be understood that the various features, aspects and functionality described in one or more of the individual embodiments are not limited in their applicability to the particular embodiment with which they are described, but instead can be applied, alone or in various combinations, to one or more of the other embodiments of the invention, whether or not such embodiments are described and whether or not such features are presented as being a part of a described embodiment. Thus the breadth and scope of the present invention should not be limited by any of the above-described exemplary embodiments.

Terms and phrases used in this document, and variations thereof, unless otherwise expressly stated, should be construed as open as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

A group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise. Furthermore, although items, elements or components of the invention may be described or claimed in the singular, the plural is contemplated to be within the scope thereof unless limitation to the singular is explicitly stated.

The presence of broadening words and phrases such as “one or more,” “at least,” “but not limited to” or other like phrases in some instances shall not be read to mean that the narrower case is intended or required in instances where such broadening phrases may be absent. The use of the term “module” does not imply that the components or functionality described or claimed as part of the module are all configured in a common package. Indeed, any or all of the various components of a module, whether control logic or other components, can be combined in a single package or separately maintained and can further be distributed across multiple locations.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination or as suitable in any other described embodiment of the invention. Certain features described in the context of various embodiments are not to be considered essential features of those embodiments, unless the embodiment is inoperative without those elements.

Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

What is claimed is:

1. A method for accessing computers via text messages, comprising:
receiving a first text message from a wireless unit by a local short message service receiver connected to a computer;
converting the first text message into executable commands for the computer;
executing commands via the computer during a data service session;
converting results from the computer back into a second text message; and
sending the second text message from the local short message service receiver to the wireless unit.

2. The method of claim 1, wherein the local short message service receiver is connected to the computer via a universal serial bus.

3. The method of claim 1, wherein the local short message service receiver is connected to the computer via a local wireless network.

4. The method of claim 1, wherein the local short message service receiver is a landline phone.

5. The method of claim 1, wherein the local short message service receiver is an IP phone.

6. The method of claim 1, wherein the first and the second text messages are encrypted.

7. The method of claim 1, wherein the local short message service receiver unit is programmed to initiate the data service session only from preset numbers.

8. The method of claim 1, wherein GPS signals of the wireless unit are shared in the data service session.
